(19) United States
(12) Patent Application Publication
(10) Pub. No.: US 2005/0279439 A1
(43) Pub. Date: Dec. 22, 2005

(54) Automatic tire pressurizing device

(76) Inventor: Bjorn Wessman SR., Gothenburg (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/150,364

(22) Filed: Jun. 10, 2005

(30) Foreign Application Priority Data
Jun. 11, 2004 (EP) 04013710

(51) Int. Cl. B60C 23/10

(52) U.S. Cl. 152/419

(57) ABSTRACT

The invention refers to a pneumatic tire pressurizing device for automatically pressurizing a load-bearing tire during rotation thereof over a surface, said tire comprising a tire volume comprising compressed air having a predetermined tire pressure. The pressurizing device comprises a compression unit connected to a movable device. The pressurizing device is connectable to a wheel comprising the tire, and when connected to the wheel the compression unit is arranged to compress air in the compression chamber when the movable device, starting from a negative position, is affected by a sudden increase of the tire pressure due to deformation of the tire when passing an irregularity in the surface, wherein said compression unit is arranged to feed the compressed air in the compression chamber to the tire volume via the pressure chamber.

### TECHNICAL FIELD

The invention refers to a pneumatic tire pressurizing device for automatically pressurizing a load-bearing tire during rotation thereof over a surface. The pressurizing device comprises a housing encompassing an inner space. The tire comprises a tire volume comprising compressed air having predetermined tire pressure.

### BACKGROUND ART

Vehicles are equipped with wheels that rotate over a surface when the vehicle is moved. Most vehicles use a wheel comprising a tire fitted onto a rim which is mounted on a wheel disc. In the field of vehicles it is known that the tire pressure of the wheel is of the utmost importance for the performance of the vehicle. Therefore, all vehicle users are informed via manuals what predetermined tire pressure is suitable for what operating condition, i.e. load, speed, etc. One problem with the wheel arrangements of today is that air slowly leaks from the tire. Even though the leakage is small it forces the user of the vehicle to monitor the tire pressure on occasion and to refill when the tire pressure is below the predetermined value. If the user neglects to always keep the tire pressure as close to the predetermined value as possible, the performance of the vehicle may be worsened. If the tire pressure gets too low, the vehicle may perform so bad at high speeds that the vehicle becomes dangerous for the user and for fellow road users.

There is thus a need for an automatic pressurizing device that ensures that the tire pressure always is kept close to the predetermined level.

### SUMMARY OF THE INVENTION

The invention is a pneumatic tire pressurizing device for automatically pressurizing a load-bearing tire during rotation thereof over a surface. The pressurizing device is connectable to a wheel including the tire, the tire having a tire volume of compressed air and a predetermined tire pressure. The tire pressurizing device comprises a housing encompassing an inner space, a movable device connected to the housing and delimiting the inner space, a compression unit having a compression chamber, the compression unit connected to the movable device (21), and a pressure chamber conduit in fluid communication with the pressure chamber. The pressure chamber is arranged to allow the compressed air in the tire volume to flow into the pressure chamber and into contact with the movable device such that when the movable device is affected by an increase of the tire pressure, the compression unit is arranged to feed the compressed air in the compression

The advantage of the invention lies in that the pressurizing device automatically refills the tire and compensates for any pressure loss due to minor and normal leakage. Testing has shown that it is normal for a car tire to loose 15% of a predetermined tire pressure of 2 bar during 1 year when driving 2000 km. The irregularities in the surface may cause pressure increase peaks of about 20% of the tyre pressure. The pressure peaks causes enough movement of the membrane to cause compression of air in the compression unit.

According to one embodiment the inner space comprises an outer chamber comprising the compression chamber and a balancing chamber. The balancing chamber is in fluid communication with ambient air via a balancing chamber conduit, enabling a neutral air pressure in the balancing chamber.

According to one embodiment the membrane is arranged to be balanced against the tire pressure in the pressure chamber by a first resilient means such that the membrane, compared to the reference position, has the negative position when the tire pressure is lower than the predetermined tire pressure and a positive position when the tire pressure is above the predetermined tire pressure. Both the negative and the positive positions are relative positions that changes with the tire pressure.

The compression unit is advantageously arranged such that when the membrane is in the negative position the compression chamber is in fluid communication with ambient air via an air intake conduit and such that when the membrane is in a positive position the compression chamber is hindered from fluid communication with the ambient air. Since the compression chamber in the positive position is hindered from fluid communication with ambient air, the air in the compression chamber may be compressed by the compression chamber diminishing its volume.

According to one embodiment the compression unit comprises a piston and the compression chamber. The piston is attached to the membrane and extends from the membrane into the compression chamber. The compression chamber has an inner circumferential geometry corresponding to the outer circumferential feature of the piston. The outer circumferential dimension of the piston may advantageously be smaller than the inner circumferential dimension of the compression chamber, such that the piston may slide with an acceptable degree of friction in the compression chamber. The gap width between the piston and compression chamber cannot be so large that the air in the compression chamber may leak during the compression phase, because this would diminishing the compression of the air in the compression chamber.

According to one embodiment the piston is cylindrical with two opposing first and second end surfaces and a therebetween extending envelope surface. The piston comprises a first conduit extending from a first opening in the first end surface to a second opening, and a second conduit extending from the second opening to a third opening in the second end surface. The piston may in another embodiment have another cross-section than a circular, for example, oval, rectangular, or triangular. The cross-section of the compression chamber will of course vary with the cross-section of the piston.

According to one embodiment the membrane has a membrane opening essentially aligned with the first opening. The first and second conduits together with the membrane opening form an open passage between the compression chamber and the pressure chamber.

According to one embodiment the second opening is narrower than the first conduit and the piston comprises a first valve placed in the first conduit against the second opening in a first position.

According to one embodiment the first valve is balanced by a second resilient means in the form of a spring extending in the direction of the first conduit.

The piston is arranged to be displaced in a sliding direction from the negative position to the positive position when the tire pressure increases from a value below the predetermined tire pressure to a value equal to or above the predetermined tire pressure. The sliding direction is defined by the direction in which the piston is guided by the compression chamber. When the tire pressure is equal to or above the predetermined tire pressure, the air intake conduit is closed by the envelope surface. The tire pressure may be higher than the predetermined tire pressure due to several reasons. One reason is that the user has filled too much air into the tire. Another reason is that the surface on which tire is rolled has irregularities that deform the tire causing a sudden increase of the tire pressure. When the piston is displaced in the sliding direction from the negative position to the positive position, the air in the compression chamber is compressed by the piston movement.

According to one embodiment the second resilient means is arranged to release the first valve when the compressed air exercises a predetermined air pressure on the first valve.

According to one embodiment the compression unit is arranged to feed the compressed air in the compression chamber to the tire volume via the pressure chamber when the first valve is released.

The second surface advantageously has a lesser area than the membrane and the pressure peaks causing the membrane to move thus gives enough energy to the piston to compress the air in the compression chamber into a pressure exceeding the pressure in the pressure chamber. The theory behind a larger object being subject to one pressure pressing on a smaller object causing a higher pressure due to the difference in area is well known in the theory of fluid dynamics and the science of hydraulics.

Furthermore, the pressure peak returns to a lower value after having pushed the membrane in the positive direction. This lower value allows also air of lesser pressure increases of the compressed air to be fed to the tyre volume.

According to one embodiment the pressurizing device comprises a second air valve intended to be used for inflating and deflating the tire, wherein the second air valve is connected to the pressure chamber via a second air valve conduit.

The pressurizing device may be mounted on the rim, or on the wheel disc or on an air valve already existing in the wheel. Different embodiments will be explained further in connection to a number of figures.

The pressurizing device may be made from any durable light material, for example, plastic, light metal, ceramics or a combination of materials.

The surface of the road may be a tar-macadamed road, a gravel road, an asphalt road or any other suitable surface material allowing a vehicle to pass. The tire comprises a tire volume comprising compressed air having predetermined tire pressure. The predetermined tire pressure depends on numerous factors. For example, the construction of the tire, the material in the tire, the vehicle load, and the rotational speed, etc. The knowledge of suitable predetermined tire pressures for different situations are well known in prior art. The predetermined tire pressure preferably refers to the tire pressure when the vehicle is standing still.

### BRIEF DESCRIPTION OF DRAWINGS

The invention will below be explained in connection to a number of figures, where;

FIG. 1 schematically teaches a cross-section of a tire pressurizing device according to a first embodiment of the invention mounted on a wheel;

FIG. 2 schematically teaches a cross-section of a tire pressurizing device according to a second embodiment of the invention mounted on a wheel, where the tire pressurizing device is in a negative position;

FIG. 3 schematically teaches a cross-section of a tire pressure according to FIG. 2, but where the tire pressurizing device is in a positive position;

FIG. 4 schematically teaches a magnified cross-section of a compression unit according to FIGS. 1-3, and where;

FIG. 5 schematically teaches a magnified cross-section of a compression unit according to another embodiment of the invention, and where;

FIG. 6 schematically teaches a cross-section of a tire pressurizing device according to a third embodiment of the invention mounted on a wheel, where the tire pressurizing device is in a negative position.

### EMBODIMENTS OF THE INVENTION

The common features in the enclosed figures are denoted with the same reference numbers.

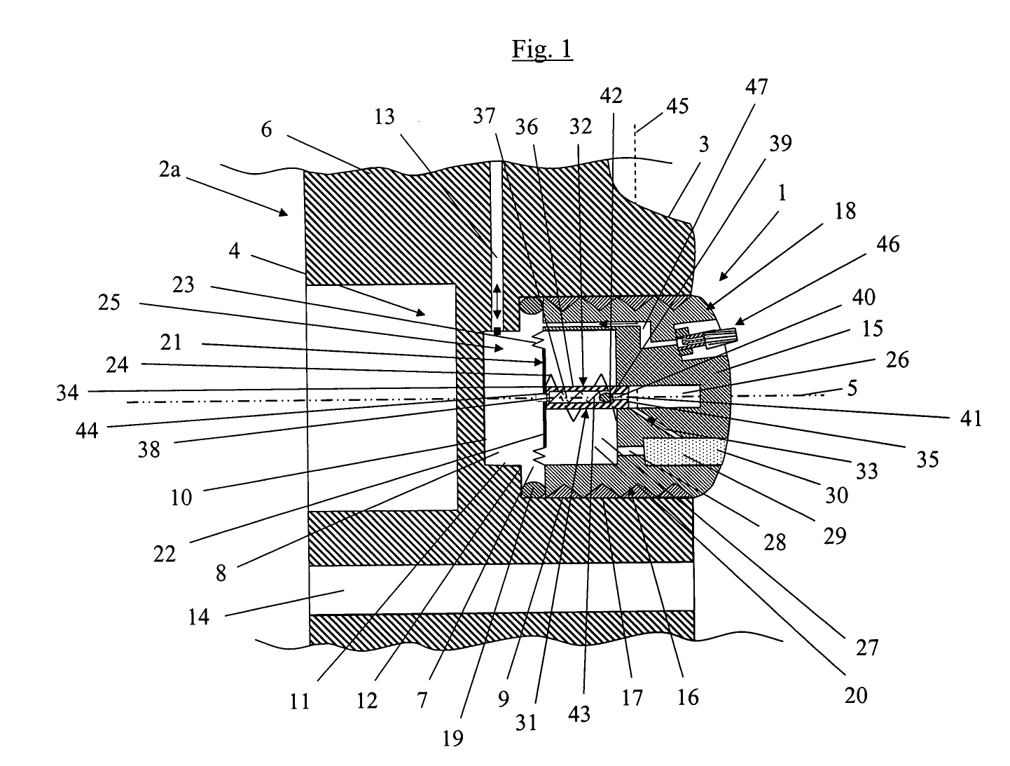

FIG. 1 schematically teaches a cross-section of a tire pressurizing device 1 according to a first embodiment of the invention mounted on a wheel 2. The wheel 2 comprises a load bearing tire (not shown) mounted on a rim (not shown) comprising a tire volume comprising compressed air with a predetermined tire pressure. The wheel also comprises a wheel disc 2a (or nave) joined to the rim. The tire pressurizing device 1 is arranged for automatically pressurizing the load-bearing tire during rotation thereof over a surface.

FIG. 1 shows only a part of the wheel disc 2a comprising a central part 4 with a central axis. The wheel disc 2a comprises a number of spokes 6 extending in the radial direction from the central part 4 to the rim. The central part is arranged with a cylindrical opening 7 and a cylindrical cavity 8 with a lesser diameter than the cylindrical opening 7 and arranged in fluid communication with the cylindrical opening 7. In FIG. 1, the cylindrical cavity 8 is arranged coaxially with the cylindrical opening 7. The cylindrical opening 7 is delimited by a circumferential first wall 9 being threaded. The cylindrical cavity 8 is delimited by a circular bottom wall 10 and a circumferential second wall 11 extending from the bottom portion to the cylindrical opening 7. The cylindrical cavity 8 transitions into the cylindrical opening 7 by the second circumferential wall being transitioned into a circumferential ledge 12 extending in a radial direction, i.e. essentially perpendicular to the direction of extension of the second wall. The ledge extends in the radial direction from the second wall to the first wall.

I FIG. 1, a channel 13 is arranged in the wheel disc 2a in the spoke 6 connecting the inner volume of the tire with the cylindrical cavity 8. The channel 13 opens out into the inner volume and the cylindrical cavity 8 and penetrates thus also the rim. FIG. 1 also shows one hole 14 at a distance from the centre axis intended to receive a bolt for attachment of the wheel 2 to an automobile.

In FIG. 1, the tire pressurizing device 1 comprises a housing 15 having an outer circumferential portion 16 being equipped with threads 17 and a top portion 18. The pressuring device is screwed into the cylindrical opening 7 in the centre of the wheel disc 2a. One benefit of this embodiment is that the pressurizing device 1 is arranged symmetrically in view of the rotational axis of the wheel 2. Another benefit is that the pressurizing device 1 is placed at a maximum distance from the ground surface, which diminishes the risk of dirt from the ground surface and water from puddles soiling the pressurizing device 1. The pressuring device need not be threaded, but may in another embodiment be mounted to the wheel 2 by any other suitable attachment means, for example, by use of mechanical joint or welding, or the like.

FIG. 1 shows that the pressurizing device 1 is screwed into the opening such that the outer portion of the pressurizing device 1 is sealed in an air tight manner against the ledge by use of sealing means 19 in the form of an O-ring.

FIG. 1 shows that the tire pressurizing device 1 comprises the housing 15 partly encompassing an inner space in the form of an outer chamber 20 closed and delimited by a movable device in the form of a membrane 21 connected to the housing 15. The membrane 21 comprises a stiff section 22 and a resilient section 23. The stiff section 22 forms a middle portion of the membrane 21 and the resilient section 23 forms an outer portion enclosing the middle portion. The resilient section 23 is attached to the housing 15 such that the stiff section 22 may be displaced in a sliding direction coinciding with the extension of the first conduit 37 and the second conduit 40. The membrane 21 is balanced by a first resilient means 24 attached to the stiff section 22. In FIG. 1 the resilient means is in the form of a spring, but may in another embodiment comprise another suitable resilient means.

The cylindrical cavity 8 and that part of the cylindrical opening 7 being delimited by the pressurizing device 1 when the pressurizing device 1 is screwed against the sealing means 19, together form a pressure chamber 25. The pressure chamber 25 is in direct fluid communication with the compressed air in the tire volume via a pressure chamber conduit in the form of the channel 13 in the spoke 6, when the pressurizing device 1 is connected to the wheel 2. The pressure chamber 25 and the channel 13 allows the air in the tire volume to flow into contact with the membrane 21 such that the membrane 21 is subject to the tire pressure. The first resilient means 24 balances the membrane 21 against a predetermined tire pressure.

The outer chamber 20 comprises a compression chamber 26 and a balancing chamber 27. The balancing chamber 27 is in fluid communication with ambient air via a balancing chamber conduit 28 opening out into a filter chamber 29 comprising a filter 30 for filter 30ing the ambient air. Here, ambient air refers to the air surrounding the wheel 2. The fluid communication with ambient air enables a neutral air pressure in the balancing chamber 27.

In FIG. 1, the pressurizing device 1 comprises a compression unit 31 comprising a piston 32 and the compression chamber 26. The compression chamber 26 is in fluid communication with the ambient air via an air intake conduit 33. In FIG. 1, the air intake conduit 33 opens out into the filter chamber 29.

In FIG. 1, the piston 32 is attached to the membrane 21 and extends from the membrane 21 through the balancing chamber 27 into the compression chamber 26. The piston 32 is slidably housed in the compression chamber 26 for movement in the sliding direction. Here, sliding direction refers to the direction of movement of the piston 32 in the compression chamber 26 acting as a cylinder for the piston 32.

In FIG. 1, the piston 32 is cylindrical with two opposing first and second end surfaces 34, 35 and a therebetween extending envelope surface 36. The piston 32 comprises a first conduit 37 extending from a first opening 38 in the first end surface 34 to a second opening 39, and a second conduit 40 extending from the second opening 39 to a third opening 41 in the second end surface 35. The second opening 39 is narrower than the first conduit 37. The piston 32 comprises a first valve 42 placed in the first conduit 37 against the second opening 39 in a first position. The first valve 42 is balanced by a second resilient means 43 in the form of a spring extending in the direction of the first conduit 37. The membrane 21 has a membrane opening 44 essentially aligned with the first opening 38. The membrane opening 44 and the first opening 38 together form a passage for fluid communication. The piston 32 is attached to the membrane 21 in an air tight manner such that air may be passed from the outer chamber 20 to the pressure chamber 25, via the conduits in the piston 32 and the membrane opening 44 only. In another embodiment the membrane 21 and the piston 32 may be formed in one air tight piece.

The membrane 21 is arranged to be balanced against the tire pressure in the pressure chamber 25 by the first resilient means 24 such that the membrane 21 compared to a reference position 45 has a negative position when the tire pressure is lower than the predetermined tire pressure and a positive position when the tire pressure is above the predetermined tire pressure. FIG. 1 shows the membrane 21 in the negative position and that the compression chamber 26 is in fluid communication with the ambient air via the air intake conduit 33 when the membrane 21 is in the negative position.

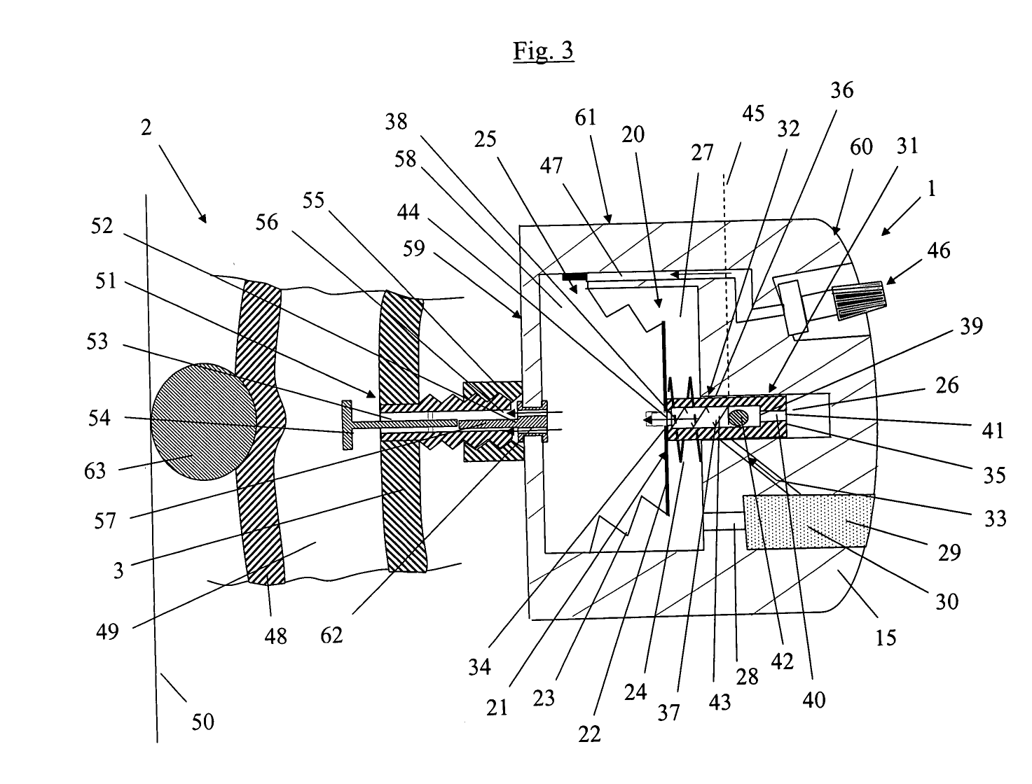

The compression unit 31 is arranged to compress the air in the compression chamber 26 when the membrane 21, starting from the negative position, is pushed in the direction of the positive position due to an increase of the tire pressure, and thus the air pressure in the pressure chamber 25, due to deformation of the tire when passing an irregularity in the ground surface. Referring to FIG. 1, the piston 32 would be displaced in the sliding direction from the negative position to a positive position (see FIG. 3) where the air intake conduit 33 would be closed by the envelope surface 36 and the air in the compression chamber 26 would be compressed by the piston 32 movement. When the piston 32 has compressed the air in the compression chamber 26, the compression unit 31 is arranged to feed the compressed air in the compression chamber 26 to the tire volume via the pressure chamber 25. The second resilient means 43 is arranged to release the first valve 42 when the compressed air exercises a certain pressure on the valve. This will below be explained further in connection to FIG. 3.

In FIG. 1, the pressurizing device 1 comprises a second air valve 46 intended to be used for inflating and deflating the tire. The second air valve 46 is placed in the top portion 18 and is connected to the pressure chamber 25 via a second air valve conduit 47.

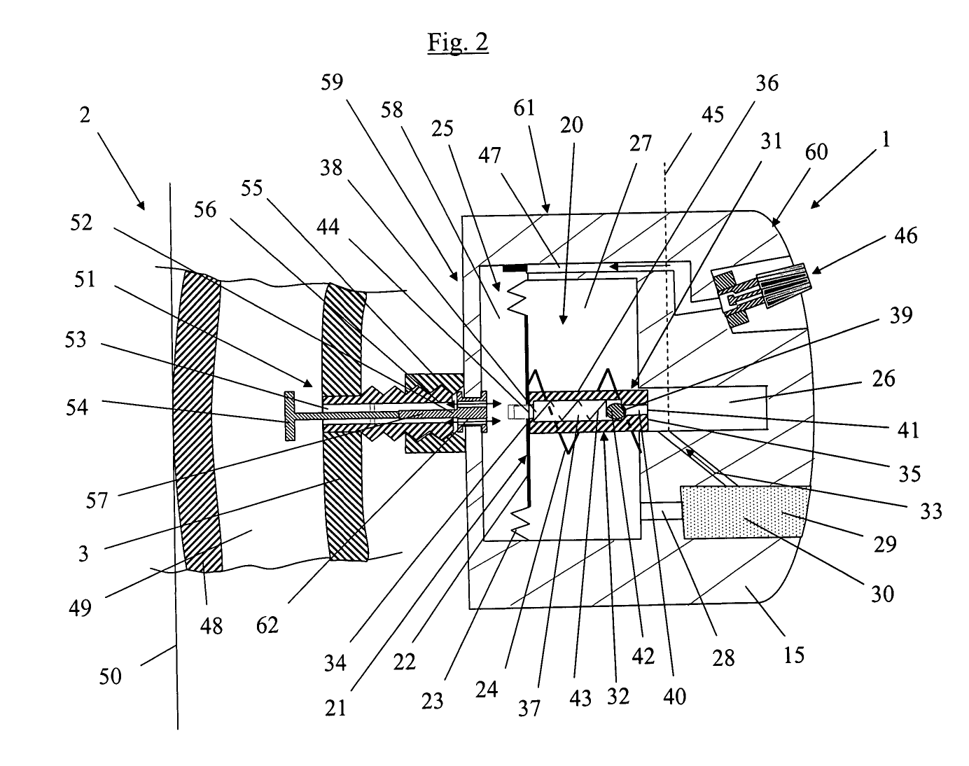

FIG. 2 schematically teaches a cross-section of a tire pressurizing device 1 according to a second embodiment of the invention mounted on a wheel 2. FIG. 2 shows a part of the rim 3 and the tire 48 and the therebetween enclosed tire volume 49. In FIG. 1 the tire 48 rolls over a ground surface 50.

The compression unit 31 and the membrane 21 described in connection to FIG. 1 is the same as in FIG. 2. In FIG. 2, the tire pressurizing device 1 is in the negative position as in FIG. 1.

In FIG. 2, the wheel 2 comprises a third air valve 51 intended to be used for inflating and deflating the tire. The third air 51 valve is mounted on the rim 3. The third air valve 51 comprises an opening 52 and a third air valve conduit 53 opening out into the tire volume 49. The third air valve conduit 53 comprises a non-return valve 54 for closing the third air valve conduit 53 from letting out compressed air from the tire volume 49.

In FIG. 2, the pressurizing device 1 is mounted to the wheel 2 via the third air valve 51. In FIG. 2, the pressurizing device 1 is screwed onto the third air valve 51 via an adapter 55 comprising an adapter conduit 56. The adapter 55 is mounted onto the housing 15 or may be a part of the housing 15. The adapter 55 comprises a pin 57 arranged for penetrating the opening 52 in the third air valve 51 and to push the non-return valve 54 into an open position, when the pressurizing device 1 is screwed onto the third air valve 51. When the non-return valve 54 is in the open position the compressed air in the tire volume 49 can flow into the third air valve conduit 53 and the adapter conduit 56.

FIG. 2 shows that the tire pressurizing device 1 comprises a housing 15 encompassing an inner space divided by a membrane 21 connected to the housing 15 into an inner chamber 58 and the outer chamber 20. The housing 15 comprises a bottom portion 59, a top portion 60 and a therebetween extending side portion 61.

The pressurizing device 1 comprises a connection conduit 62 arranged in the bottom portion 59 to enable the inner chamber 58 to be in direct fluid communication with the compressed air in the tire volume 49 via the third air valve conduit 53 and the adapter conduit 56, when the pressurizing device 1 is connected to the wheel 2. In FIG. 2, the third air valve conduit 53 and the adapter conduit 56 and the connection conduit 62 together form a pressure conduit and the inner chamber 58 forms a pressure chamber 25.

The membrane 21 is arranged to be balanced against the tire pressure in the inner chamber 58, i.e. in the pressure chamber 25, by the first resilient means 24.

In FIG. 2, the pressurizing device 1 comprises the second air valve 46 intended to be used for inflating and deflating the tire 48. The second air valve 46 is connected to the inner chamber 58 via the second air valve conduit 47.

FIG. 3 schematically teaches a cross-section of a tire pressurizing device 1 according to FIG. 2, but where the tire pressurizing device 1 is in a positive position. The tire 48 has been deformed due to an irregularity 63 in the surface on which the tire 48 is rolled. The deformation of the tire 48 has caused diminished tire volume 49 and thereby a sudden increase of the tire pressure. The increased tire pressure has pressed the membrane 21 from the negative position in FIGS. 1 and 2, in the sliding direction, to a positive position. The piston 32 has thus moved correspondingly in the sliding direction into the compression chamber 26 so that the air intake conduit 33 is blocked by the envelope surface 36. The movement of the piston 32 compresses the air in the compression chamber 26 until the pressure reaches a predetermined value. When the predetermined value is reached, the first valve 42 presses on the second resilient means 43 with such force that the second resilient means 43 fails by being compressed. The first valve 42 then moves in the first conduit 37, in a direction from the second opening 39 to the first opening 38, thereby opening the second opening 39 such that the compressed air in the compression chamber 26 may flow in the first and second conduits 37, 40, through the opening 44 in the membrane 21 and into the inner chamber 58 and thus into the pressure chamber 25 and the tire volume 49, thereby adding air volume to the tire volume 49 and thus increasing the tire pressure.

After the tire 48 has passed the elevated irregularity 63, the tire pressure goes back to the prior tire pressure plus the increased pressure due to the compressed air fed to the tire volume. If the new tire pressure is below the predetermined tire pressure the membrane 21 is displaced into the negative position. The piston 32 is then accordingly slid into the negative position shown in FIG. 1 or 2, such that the air intake conduit 33 is uncovered enabling air to flow into the compression chamber 26. This procedure is repeated until enough compressed air has been fed into the tire volume 49 for the tire pressure to reach its predetermined value. When the tire volume has reached the predetermined tire pressure, the membrane 21 is pushed into the reference position 45 where the piston envelope surface 36 closes the air intake conduit 33. When enough air has leaked from the tire 48, the membrane 21 reaches the negative position and compressed air is fed to the tire volume 49 via the stochastic movement of the membrane 21 due to the instantaneous pressure pulses due to the irregularities 63 in the surface.

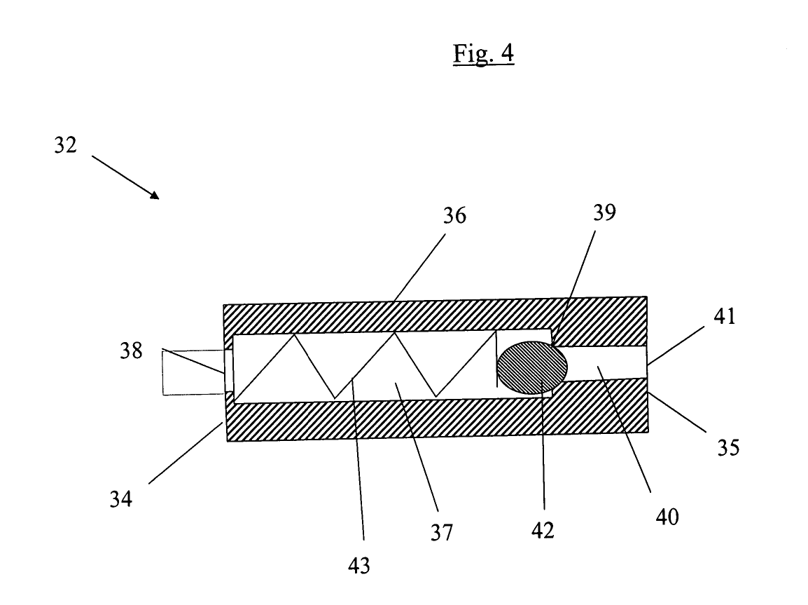

FIG. 4 schematically teaches a magnified cross-section of a compression unit 31 according to FIGS. 1-3.

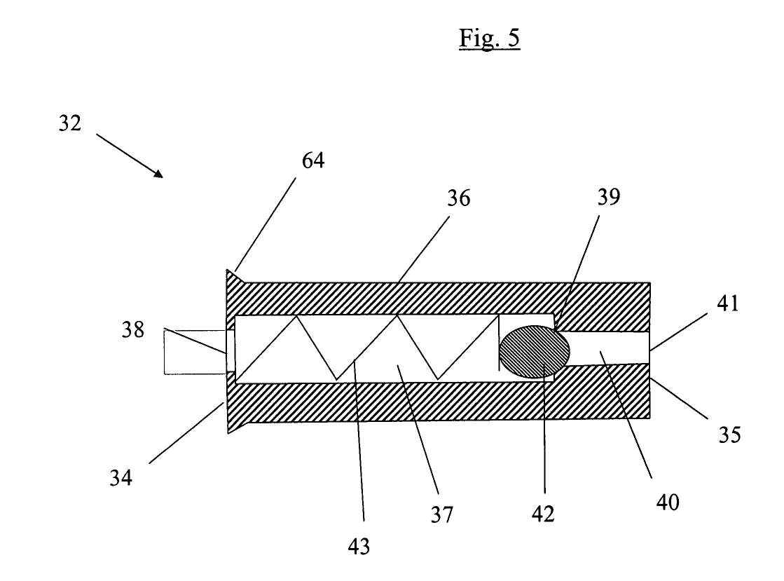

FIG. 5 schematically teaches a magnified cross-section of a compression unit 31 according to another embodiment of the invention. The piston 32 is formed with a cone shaped flange 64 in the envelope surface 36 extending in the radial direction. The flange 64 makes the first end surface 34 larger than the second end surface 35. The flange transitions from the first end surface 34 into the cylindrical envelope surface 36 at a predetermined distance from the first end surface 34. The flange 64 is intended to jam the opening between the compression chamber 26 and the outer chamber 20 in an air tight manner should the membrane 21 fail or brake.

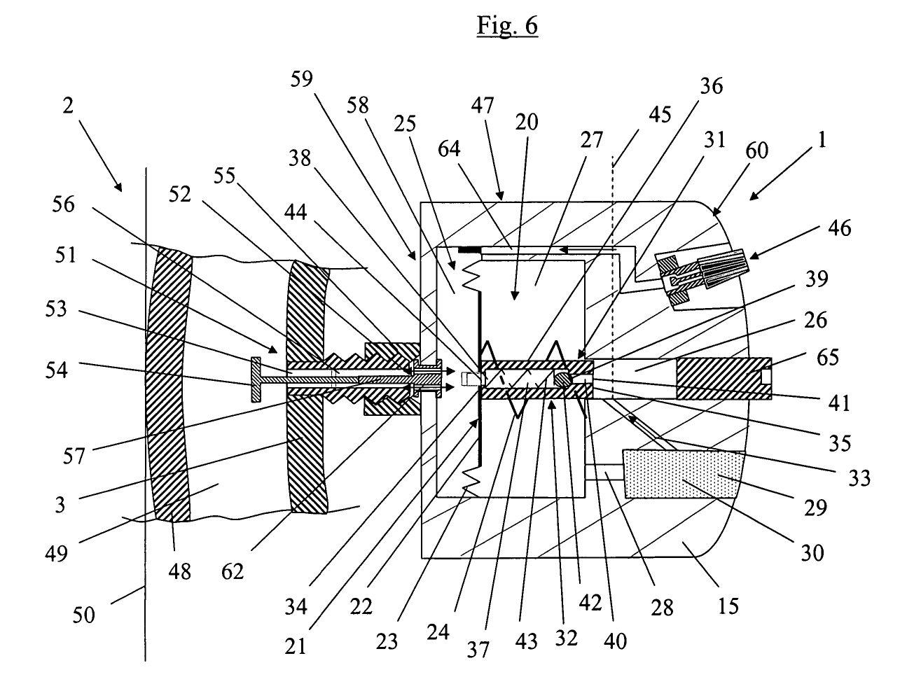

FIG. 6 schematically teaches a cross-section of a tire pressurizing device 1 according to a third embodiment of the invention mounted on a wheel 2, where the tire pressurizing device 1 is in a negative position. FIG. 6 differs from FIG. 2 only in that an adjusting means 65 in the form of a bolt, or the like, is arranged in the housing 15 and being part of the compression chamber enclosure. The adjusting means 65 may be moved in the sliding direction for diminishing the volume of the compression such that different air pressures may be reached in the compression chamber 26 for a given piston 32 movement and a given resilient strength of the second resilient means 43. The smaller the volume of the compression chamber 26 the larger the pressure of the compressed air.

1. A pneumatic tire pressurizing device for automatically pressurizing a load-bearing tire during rotation thereof over a surface, the pressurizing device being connectable to a wheel including the tire, the tire having a tire volume of compressed air and a predetermined tire pressure, the tire pressurizing device comprising:
a housing encompassing an inner space;
a movable device connected to the housing and delimiting the inner space;
a compression unit having a compression chamber, the compression unit connected to the movable device (21); and
a pressure chamber conduit in fluid communication with the pressure chamber;
wherein the pressure chamber is arranged to allow the compressed air in the tire volume to flow into the pressure chamber and into contact with the movable device such that when the movable device is affected by an increase of the tire pressure, the compression unit is arranged to feed the compressed air in the compression chamber to the tire volume via the pressure chamber.

2. The pneumatic tire pressurizing device according to claim 1, wherein the pressure chamber comprises a cavity arranged in a wheel disc and a part of an opening arranged in the wheel disc being delimited by the pressurizing device when the pressurizing device is mounted in the opening.

3. The pneumatic tire pressurizing device according to claim 2, wherein the pressure chamber conduit comprises a channel arranged in the wheel disc.

4. The pneumatic tire pressurizing device according to claim 3, wherein the channel is arranged in a wheel disc spoke.

5. The pneumatic tire pressurizing device according to claim 1, further comprising a first air valve, second air valve, third air valve, and a third air valve conduit, wherein the third air valve air valve conduit opens out into the tire volume and is arranged for inflating and deflating the tire.

6. The pneumatic tire pressurizing device according to claim 5, wherein the movable device is arranged to delimit the inner space into an inner chamber and an outer chamber.

7. The pneumatic tire pressurizing device according to claim 6, wherein the inner chamber forms the pressure chamber.

8. The pneumatic tire pressurizing device according claim 1 wherein the inner space comprises an outer chamber comprising the compression chamber and a balancing chamber.

9. The Pneumatic tire pressurizing device according to claim 8, wherein the balancing chamber is in fluid communication with ambient air via a balancing chamber conduit.

10. The pneumatic tire pressurizing device according to claim 1, wherein the compression unit further comprises a piston.

11. The pneumatic tire pressurizing device according to claim 10, wherein the piston is attached to the movable device and extends from the movable device into the compression chamber.

12. The pneumatic tire pressurizing device according to claim 11, wherein the piston has two opposing first and second end surfaces having a therebetween extending envelope surface, a first conduit extending from a first opening in the first end surface to a second opening, and a second conduit extending from the second opening to a third opening in the second end surface.

13. The pneumatic tire pressurizing device according to claim 1 further comprising a first and second air valve, and a second air valve conduit, the second air valve intended to be used for inflating and deflating the tire, wherein the second air valve is arranged in fluid communication with the pressure chamber via a second air valve conduit.

14. The pneumatic tire pressurizing device according to claim 1 wherein the movable device is a membrane.
